(19) United States
(12) Patent Application Publication
(10) Pub. No.: US 2016/0060585 A1
(43) Pub. Date: Mar. 3, 2016

(54) Consumer Beer Additive

(71) Applicants: Laurence E. Burgess, Boulder, CO (US); Daniel H. Darden, Boulder, CO (US)

(72) Inventors: Laurence E. Burgess, Boulder, CO (US); Daniel H. Darden, Boulder, CO (US)

(21) Appl. No.: 14/471,230

(22) Filed: Aug. 28, 2014

(51) Int. Cl. C12C 5/02

(52) U.S. Cl. CPC C12C 5/026

(57) ABSTRACT

The present invention provides a method for a consumer to enhance the quality of an average glass or pitcher of beer at the point of consumption by placing an additive into the glass or pitcher and allowing its extracts to mix with the beer. The mixture of food grade chemicals and natural improves the beer drinking experience in the major physical and sensory aspects that make for an above average beer. These include but are not limited to: an increased bitterness and an improved aroma and flavor of hops and a darker appearance. The method of the present invention allows a beer consumer to improve their sensory experience while drinking the treated beer. This additive can be stored in individual plastic or foil pouches or glass or containers intended to be carried in the pocket when visiting bars, restaurants, sporting events, or other drinking establishments or events that serve beer or make beer available. The additive is also intended to contain preservatives that allow for a minimum six month shelf life at room temperature or slightly higher temperatures.

### CROSS-REFERENCE TO RELATED APPLICATIONS: (NONE)

### BACKGROUND OF THE INVENTION

1. Field of the Invention

The present invention relates broadly to beer beverage additives to be used by a beer consumer in a bottle, can, or draught pour of beer that has been opened or poured into a glass or pitcher, for improving both the flavor and certain desirable physical characteristics of the beer such as appearance and odor.

2. Description of Prior Art

Beer is a popular drink around the world and is produced in vast amounts in almost every country enabling broad and affordable access. Unfortunately, only a small percentage of beer is considered outstanding by experts or those skilled in the art of brewing making it unattainable for the average person. Furthermore, outstanding beer is often the result of a more complicated, costly process and thus is less affordable. The art of beer degustation has developed over the centuries at first in order to be sure to avoid a dangerous bottle, one that had spoiled. Today, it delineates the preferred attributes of the beer drinking experience. Considering the important physical and sensory aspects of the most expensive and desired beers of the world, it would be advantageous if a consumer could improve an average bottle, can, glass of beer by adding a combination of ingredients to the bottle or can once it has been opened or to the glass or pitcher once it has been poured. Through trial and error testing, the present invention claims a unique combination of chemical and food additives which serve to interact with the beer and with each other to improve the beer drinking experience.

As background, it is first necessary to review the universally agreed upon elements of the finest glass of beer; that is, what are the desirable aspects of many of the more expensive beers? There are many aspects of beer, and each style has its own nuances. There are some basic physical and sensory aspects of great beers that most experts can agree upon: Bitterness, Hop Flavors, and Hop Aromas. Bitterness in beer is generally derived from hop additions made during the beginning of the boiling step. The phenomenon most responsible for this bitter flavor is the isomerization of the alpha acids contained in hop cones when boiled. Hop flavors and aromas come from the essential oils also contained in hop cones and can add aromas and flavors that have been called floral, citrus, fruity, grassy, piney, herbal, and spicy.

Adding flavorings to food and beverages is taught in numerous patents that give specific combinations of flavors for specific foods. For example, U.S. Pat. No. 5,380,540 (Yamanaka, et al.) describes the use of the additive of triose-reductone, hydroxymalon-dialdehyde or hydroxypyruvaldehyde in order to increase the saltiness or to modify the sourness of food. Neither of these tastes would enhance any beer.

U.S. Pat. Application number 20120207903, Consumer Wine Additive, describes the use of an additive such as “liquid smoke” or vanillin to improve the flavor or wine and there is no mention of any intended use for beer.

U.S. Pat Application number 20130309390, Combination Alcoholic Beverage and Separately Packaged Flavorant, describes a wood-based derivative to be packaged and sold together with a bottle of distilled spirits to increase the “oakiness” of the spirit drink. There is no mention of any possible application or possible benefit to the taste and appearance of beer.

There are numerous patents that describe production processes for adding hops during various stages of the manufacture of beer and are not practical for a retail consumer to perform on a single bottle or can. Likewise with the flavorings taught in U.S. Pat. No. 7,866,254 (Karasch et al.) and U.S. Pat. No. 5,102,675 (Howell et al.). While prior art may include one or more beverage flavorings, it does not combine them for the express purpose of the end consumer to control the increase in bitterness, hop flavors, and hop aromas of an individual serving of beer at the time of consumption. The present invention provides the end consumer that ability.

### SUMMARY OF THE INVENTION

The present invention is a partially or fully miscible combination of ingredients contained in a disposable and portable container. Separately, each of the ingredients improves upon one of the natural attributes of fine beers but combined, they add to the balance and overall sensory experience of the consumer. The additives of the present invention may be provided in a number of product packaging formats well known to those skilled in the art of packaging. By way of example, but without limitation, suitable packaging includes plastic, foil, or multi-layered packets or pouches. One size would be appropriate for a single glass of beer and a larger size could be available for addition to an open bottle, can, or pitcher of beer. In a preferred embodiment, a plastic container has a breakaway top which the user twists to break it off the main container, then empties the contents into an open bottle, glass or pitcher of beer prior to ingestion. In combination with commercially available beer, this consumer additive to beer enhances the physical, aromatic and flavor attributes of the beer, raising an ordinary inexpensive and/or lower calorie beer to a level approaching more expensive craft beers.

### DETAILED DESCRIPTION OF THE PREFERRED EMBODIMENT

In one aspect, some of the ingredients of the present invention enhance the flavor and aroma of the beer without altering the acidity, viscosity or other physical characteristics of the beverage. The preferred flavor enhancing ingredients include one or more of the following: Iso Alpha Extract of Hops (0.001 to 10 percent of the additive by volume) which is a condensed solution derived from Hops. An example is the product made by Hop Tech Home Brewing Company in Dublin, Calif. This enhances the bitterness of the beer. Various hop oils of differing hop varieties (0.001 to 10 percent by volume), improve the aroma and flavor or beer.

In another aspect of the present invention, it is understood that improving the flavor of beer alone is not enough to produce a superior beer-drinking experience. This requires an improvement in the color of the beer. Darker beers are generally regarded as being more full-bodied and richer in taste. Also, darkening the color of the beer will serve as an indication to the consumer that they have applied the additive to their beer. A “generally regarded as safe” food coloring will be included in the additive to darken the color of the beer.

The combinations and concentrations of each of the aforementioned ingredients can be modified by those skilled in the art of blending flavors, colors, and beer tasting depending on the needs of specific beer styles. For example, an extremely light lager beer might be enhanced with more bitterness, more hop oils, and more color darkening agents than an additive designed for an India Pale Ale which typically is more bitter, has more hop flavors and aromas, and is darker than a light lager. The following example serves to illustrate this point.

### EXAMPLE 1

An additive of 0.5 ml of iso alpha acid and 0.5 ml of Cascade hop oil when combined in 12 ounces of a commercial light lager and swirled for 3 seconds to mix, the resulting glass of beer had improved bitterness, hop flavor, and hop aroma than an untreated glass of the same beer. In a blind taste test with experienced adult beer consumers, they had a strong preference for a beer that had been treated with the additive versus that same beer left untreated.

The present invention allows for the modification of the concentration of each of the mentioned flavors or the addition of other flavors and volatile oils to be included in the additive to satisfy changing popular tastes as time goes on.

In another aspect of the present invention, it is understood that a preservative will be needed to maintain the freshness and potency of the additive for a shelf life of up to six months in typical retail store conditions. One or both of the following specific ingredients, but not limited to these specific preservatives, are needed to help preserve the additive: di-t-butyl-methyl phenol or ammonium salts. Other preservatives known to those skilled in the art could be substituted.

1. A method of improving the sensory experience of a beer consumer, comprising an after-bottling, canning, or kegging beer beverage additive which includes flavoring constituents, coloring, and preservatives. While we conceptualize this invention as occurring at the time of consumption, it can, theoretically, occur at any time after production.

2. The beer beverage additive of claim 1 wherein the flavorings include one or more of Iso-Alpha Extract in a 0.001 to 5 percent concentration by volume; Late Hop Essence (of various hop varieties) in a 0.001 to 10 percent concentration by volume; and Hop Oils (of various hop varieties) in a 0.001 to 10 percent concentration by volume.

3. The beer beverage of claim 1 containing preservatives such as di-t-butyl-methyl phenol or ammonium salts.

4. The beer beverage of claim 1 containing some “generally regarded as safe” food colorings to darken its appearance.
